(19) United States
(12) Patent Application Publication
(10) Pub. No.: US 2026/0110478 A1
(43) Pub. Date: Apr. 23, 2026

(54) ICE LEVEL SENSOR FOR AN ICE BIN IN AN ICE DISPENSER SYSTEM

(71) Applicant: Follet Products, LLC, Easton, PA (US)

(72) Inventors: Paul William Blayle, Allentown, PA (US); Thomas R. Sampson, Nazareth, PA (US); Christopher Ryan Pambianchi, Easton, PA (US); Marco A. Rotondo, Easton, PA (US); Stephen E. Rottloff, Quakertown, PA (US)

(73) Assignee: Follet Products, LLC, Easton, PA (US)

(21) Appl. No.: 18/919,899

(22) Filed: Oct. 18, 2024

(51) Int. Cl. F25C 5/187

(52) U.S. Cl. CPC F25C 5/187; F25C 2700/02

(57) ABSTRACT

The present disclosure is directed to an ice level sensor for an ice bin in an ice dispenser system. In one form, a system comprises an ice bin, a capacitive sensor, a system interface, and a processor. The sensor is positioned adjacent to the ice bin, and is configured to detect a presence of an ice nugget. The processor is configured to determine, during an ice dispensing operation of the ice dispensing system, whether the sensor generates a signal. When a number of consecutive ice dispensing operations during which the sensor generates a signal is equal to a threshold, the processor is configured to illuminate an indicator of the system interface. When the number of consecutive ice dispensing operations during which the sensor generates the signal is not equal to the threshold, the processor is configured to refrain from illuminating the indicator of the system interface.

### BACKGROUND

Beverage production systems regularly use an ice dispensing system to fill a receptacle with ice. Ice dispensing systems may include ice storage bins that store pieces of ice prior to the system dispensing the ice. It is desirable to detect when the ice within the ice storage bin reaches a low level where a programmed ice portion being dispensed is at the risk of being inaccurate.

Due to cleanability standards, to avoid contact with food such as ice, sensors to detect an ice level within an ice storage bin must not be within a food zone area, such as an area within the bin holding ice. Infrared (IR) sensors and ultrasonic sensors do not adequately address this issue because of their inability to accurately detect ice at a distance away from an ice pile due to the geometry of an ice pile and ice nuggets. Mechanical thermostats and thermistors also do not adequately address this issue due to an amount of delay in detecting a reduction in ice within the ice storage bin by the temperatures and a need to be in direct contact with the ice.

Accordingly, improved ice level sensors that are able accurately detect a low ice level within an ice storage bin are desirable.

### SUMMARY

Implementations of ice dispensing systems in the present disclosure utilize a capacitive sensor to detect a low ice level with in an ice storage bin. As discussed below, capacitive sensors can detect conductors and dielectrics through a plastic medium. This allows a capacitive sensor to detect a presence of ice in an ice storage bin while being positioned adjacent to an exterior side of the ice storage bin. Because the capacitive sensor is positioned adjacent to the exterior side of ice storage bin it is not in direct contact with ice in the ice storage bin and is not positioned in a food zone area of the ice storage bin.

In one form, the present disclosure provides a system comprising an ice bin, a capacitive sensor, a system interface, and a processor. The capacitive sensor is positioned adjacent to the ice bin in the system, where the capacitive sensor is configured to detect a presence of an ice nugget within a defined distance of the capacitive sensor. The system interface comprises a low ice level indicator.

The processor is in communication with the capacitive sensor and the system interface. Additionally, the processor is configured to determine, during an ice dispensing operation of the ice dispensing system, whether the capacitive sensor generates a low ice level signal.

When the capacitive sensor generates the low ice level signal, the processor is further configured to: determine whether a number of consecutive ice dispensing operations during which the capacitive sensor generates the low ice level signal is equal to a threshold.

When the number of consecutive ice dispensing operations during which the capacitive sensor generates the low ice level signal is equal to a threshold, the processor is configured to at least one of illuminate or activate the low ice level indicator of the system interface.

When the number of consecutive ice dispensing operations during which the capacitive sensor generates the low ice level signal is not equal to the threshold, the processor is configured to refrain from illuminating or activating the indicator of the system interface.

In another form, the present disclosure provides a method for operating an ice dispensing system utilizing a capacitive sensor. In one form of a method, a processor of the ice dispensing system determines whether the capacitive sensor generates a low ice level signal during an ice dispensing operation of the ice dispensing system.

When the processor determines that the capacitive sensor generates the low ice level signal, the processor determines whether a number of consecutive ice dispensing operations during which the capacitive sensor generates the low ice level signal is equal to a threshold. When the number of consecutive ice dispensing operations during which the capacitive sensor generates the low ice level signal is equal to a threshold, the processor at least one of illuminates or activates an indicator of the ice dispensing system. When the number of consecutive ice dispensing operations during which the capacitive sensor generates the low ice level signal is not equal to the threshold, the processor refrains from illuminating or activating the indicator of the ice dispensing system.

### BRIEF DESCRIPTION OF THE DRAWINGS

FIG. 1 is a perspective view of one form of an ice dispensing system.

FIG. 2 is a perspective view of internal components of one form of an ice dispensing system.

FIG. 3a is a top view of interior components of one form of an ice dispensing system.

FIG. 3b is a perspective view of a plug including a capacitive senor.

FIG. 4 is a cross-sectional side view of interior components of one form of an ice dispensing system.

FIG. 5 is a flow chart of one form of a method for operating an ice dispensing system utilizing a capacitive sensor.

### DETAILED DESCRIPTION

The present disclosure is directed to an ice level sensor for an ice storage bin in an ice dispensing system. Capacitive sensors provide the ability to detect a presence of ice through a plastic medium. While capacitive sensors regularly have a short range, the range is sufficient to allow a capacitive sensor to detect a presence of ice in an ice storage bin while being positioned adjacent to an exterior side of the ice storage bin. Because the capacitive sensor is positioned adjacent to the exterior side of ice storage bin, the capacitive sensor is not in direct contact with ice in the ice storage bin and is not positioned in a food zone area of the ice storage bin.

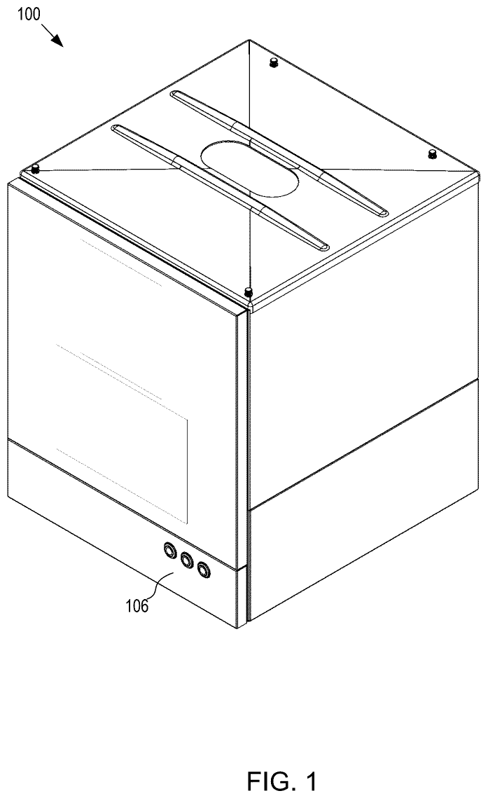

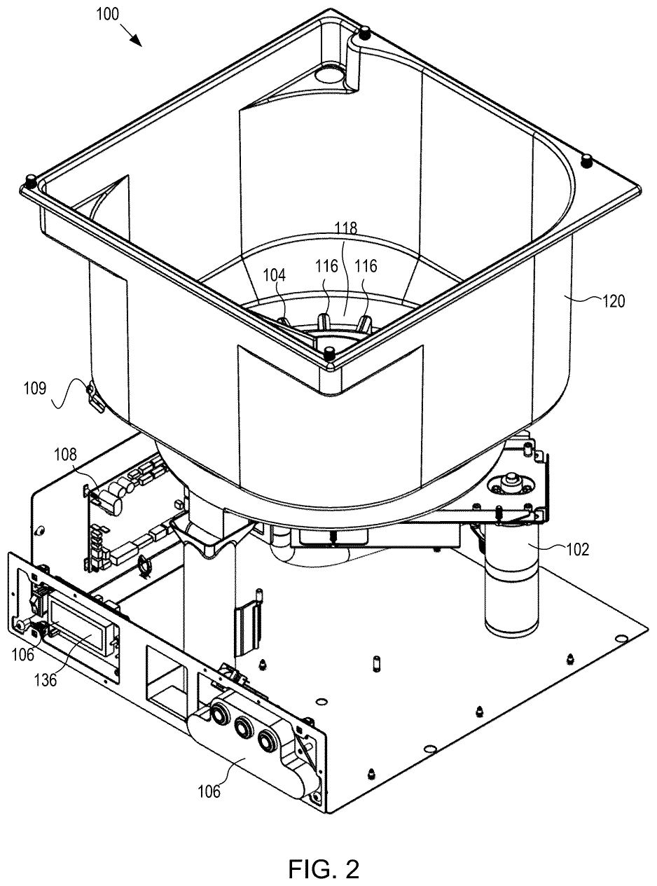

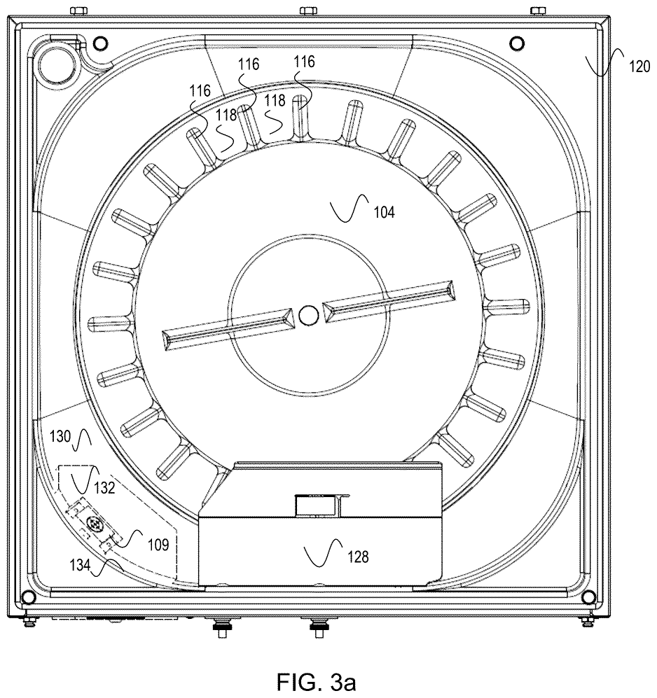

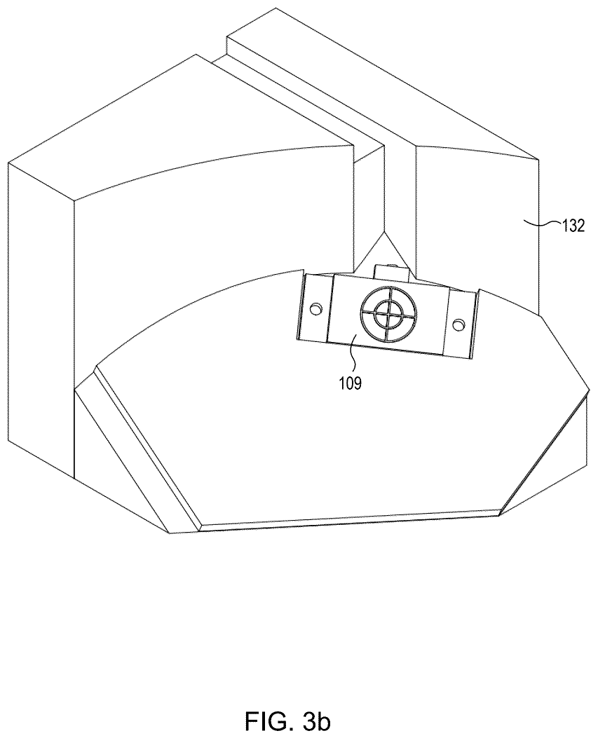

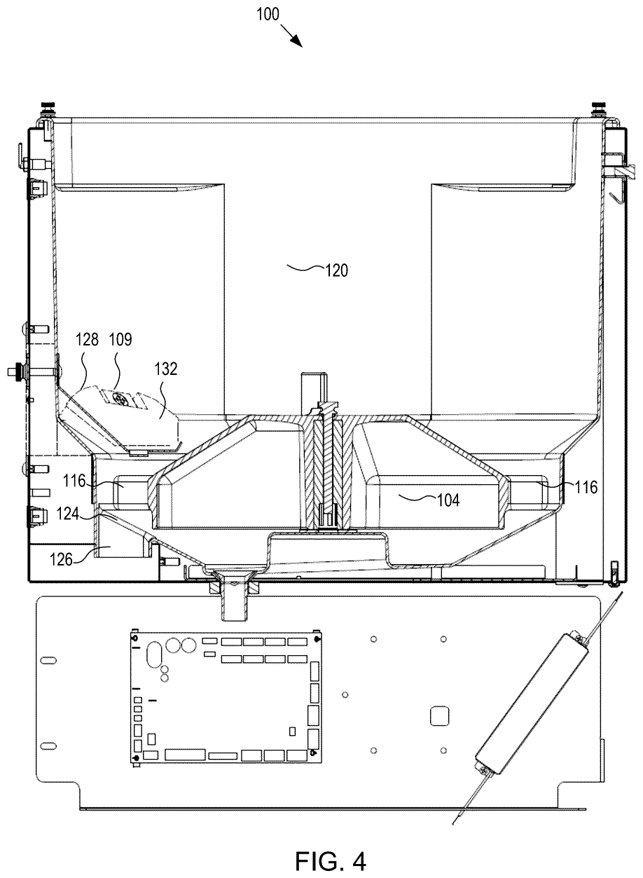

FIG. 1 is a perspective view of one form of an ice dispensing system 100; FIG. 2 is a perspective view of internal components of one form of an ice dispensing system; FIG. 3a is a top view of interior components of one form of an ice dispensing system 100; FIG. 3b is a perspective view of a plug including a capacitive sensor; and FIG. 4 is a cross-sectional side view of interior components of one form of an ice dispensing system 100.

Referring to FIGS. 2-4, an ice dispensing system 100 may include a gearmotor 102, an ice wheel 104, a system interface 106, a processor 108, a capacitive sensor 109, and an ice storage bin 120.

The ice wheel 104 is positioned within an interior of the ice storage bin 120 and is coupled with the gearmotor 102 such that as the gearmotor 102 rotates, the ice wheel 104 also rotates. In implementations described in the present application, the ice wheel 104 is configured to rotate in a counterclockwise direction. However, in other implementations, the ice wheel 104 may be configured to rotate in a clockwise direction. Rotation of the ice wheel 104 causes ice to dispense from the ice dispensing system 100. One example of an ice dispenser system configurated to operate in this manner is described in U.S. patent application Ser. No. 18/616,991, filed Mar. 26, 2024, the entirety of which is herby incorporated by reference.

As show in FIG. 3, in some implementations the ice wheel 104 defines a plurality of paddles 116 positioned around the ice wheel 104. The plurality of paddles 116 are configured to retain an amount of ice between two adjacent paddles as the ice wheel rotates 104. In some implementation, a pocket 118 for ice is defined by at least two adjacent paddles of the plurality of paddles 116, and side walls and a bottom wall of the ice storage bin 120.

As the ice wheel 104 rotates, one or more pockets 118 retaining ice rotate over an aperture 124 in a bottom of the ice storage bin 120 where ice in the pocket 118 may flow into a dispense chute 126. Ice may then flow through the dispense chute 126 and into a receptacle positioned below the ice dispensing system.

In some implementations, the ice dispensing system 100 may include a baffle 128 positioned above at least a portion of the aperture 124 such that as the ice wheel 104 rotates, the baffle 128 levels ice within a pocket 118 before that pocket 118 is positioned over the aperture 124. It will be appreciated that leveling the ice within the pocket 118 serves to ensure a consistent amount of ice is positioned in each pocket 118 before the ice is dispensed through the aperture 124 and dispense chute 126, as well as help ensure that all of the ice is dispensed from a pocket 118 when it is positioned above the aperture 124.

In some implementations, the baffle 128 additionally helps to pile ice in an area of the ice bin 130 before a pocket 118 rotates under the baffle and before the pocket 118 rotates above the aperture 124. Piling ice in this area of the bin 130 assists in filling each of the pockets 118 with ice.

The capacitive sensor 109 is positioned adjacent to an exterior wall of the ice storage bin 120 near the area of the bin 130 where ice accumulates due to rotation of the ice wheel 104 and the positioning of the baffle 128. In FIG. 3a, the capacitive sensor 109 is shown in phantom behind the shown ice storage bin 120.

In some implementations, insulation surrounds at least a portion of the ice storage bin 120 and the capacitive sensor 109 is positioned in a foam plug 132 that may be inserted into a void 134 of the insulation such that the capacitive sensor 109 is positioned adjacent to the exterior side of the ice storage bin 120. One implementation of the foam plug 132 with the capacitive sensor 109 is shown in FIG. 3B. The foam plug may additional serve to limit condensation around the capacitive sensor 109. In some implementations, the plug is held in the void by a sheet metal bracket, thereby keeping the capacitive sensor 109 in constant pressure against the ice storage bin 120 for more reliable results due to the short sensing distance of the capacitive sensor 109.

During operation, as the ice dispensing system 100 dispenses ice from the ice storage bin 120, the ice pile formed by movement of the ice wheel 104 and the baffle 128 is agitated. When agitated by the movement of the ice wheel 104, ice passes in front of the area of the ice storage bin 120 where the capacitive sensor 109 is positioned, resulting in the capacitive sensor 109 detecting the presence of ice.

Once the ice dispensing system 100 dispenses enough ice from the ice storage bin 120, the ice level falls below a detection level of the capacitive sensor 109. If the ice storage bin is not refilled, upon subsequent ice dispense activations of the ice dispensing system 100, the capacitive sensor 109 will generate a low ice level signal due to the capacitive sensor 109 not detecting the present of ice.

In some implementations, the processor 108 illuminates and/or activates an indicator 136 that indicates to a user that the ice dispensing system 100 may not have sufficient ice to dispense an accurate portion. In some implementations, the indicator 136 may be part of the system interface 106. However, in other implementations, the indicator 136 may be distinct from the system interface 106.

Further, in some implementations, the processor 108 may illuminate and/or activate the indicator 136 after the capacitive sensor 109 generates a low ice level signal for a first time after not detecting the presence of ice during an ice dispense operation. However, in other implementations, the processor 108 does not illuminate and/or activate the indicator 136 until the processor 108 receives a low ice level signal from the capacitive sensor 109 during a defined number of consecutive ice dispense operations. For example, in some implementations, the processor 108 illuminates and/or activates the indicator 136 after the processor 108 receives a low ice level from the capacitive sensor 109 during three consecutive ice dispense operations.

It will be appreciated that when ice is not dispensed from the ice storage bin 120 for an extended period of time, voids may occur within the ice pile due to ice melting away from the walls of the ice storage bin 120. As a result, during the next ice dispense operation, one of the voids could cause the capacitive sensor to generate a low ice signal even though sufficient ice is present in the ice storage bin 120. Waiting to illuminate and/or activate the indictor 136 until the processor 108 receives a low ice level from the capacitive sensor 109 during a defined number of consecutive ice dispense operations reduces a number of potential false positives that could occur due to these types of voids in the ice pile.

The system interface 106 is electronically connected to the processor 108. In some implementations, the system interface 106 comprises a user interface that may include one or more physical buttons, a touchscreen, and/or a display that allows a user to interact with the user interface 106 and select one of multiple preset sizes for ice dispensing. For example, in one implementation, a user is able to make a selection of dispensing ice for a small, medium, or large size beverage.

Further, in some implementations, the system interface 106 may comprise a program interface that is configured to communicate with other beverage systems. For example, in implementations where the ice dispensing system 100 is integrated within a larger beverage machine, the beverage machine may receive an order for a specific beverage such as a large cola. As part of preparing the large cola, the beverage machine rather than a user may send instructions via the system interface 106 to the ice dispensing system 100 to dispense ice for a large beverage.

When an input is provided to the system interface 106 whether by, for example, a user interacting with a user interface or another system providing instructions to the ice dispensing system 100, information indicating the input provided at the system interface 106 is communicated to the processor 108. The processor 108 receives the information from the system interface 106 and determines control information for the gearmotor 102 that will cause the ice dispenser system 100 to dispense an amount of ice that corresponds to the input received at the system interface 106. In some implementations, the processor 108 may determine the control information from a lookup table or other data structure stored in a memory 109.

The processor 108 communicates the control information to the gearmotor 102 as described above to dispense the desired amount of ice from the ice dispenser system. It will be appreciated that while in some implementations, the ice dispensing system may include both a processor 108 and a distinct controller for the gearmotor 102, in other implementations, the processor 108 may additionally perform operations to directly control the gearmotor 102.

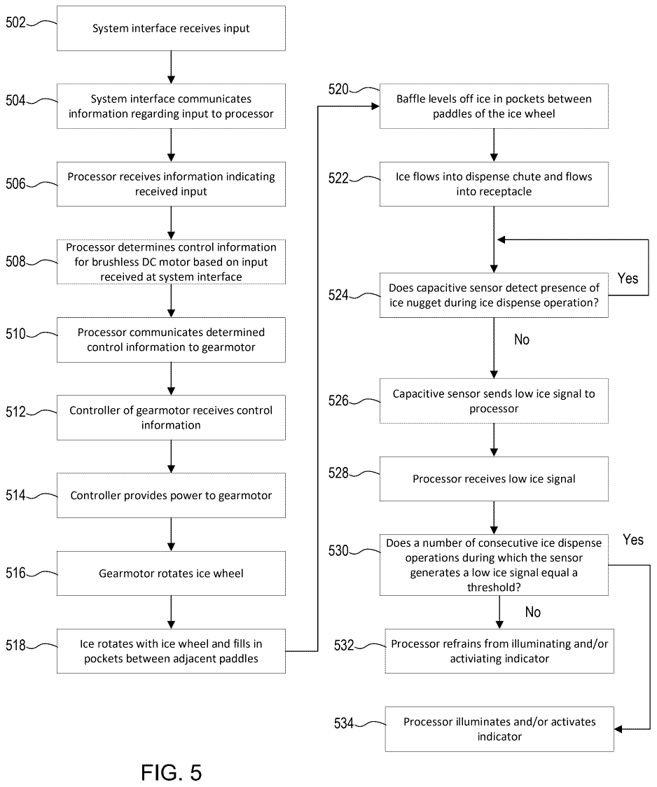

FIG. 5 is a flow chart of one form of a method for operating an ice dispensing system utilizing a capacitive sensor 109, such as the implementations of an ice dispensing system described above in conjunction with FIGS. 1-4.

At step 502 an input is received at the system interface. As discussed above, in some implementations this may include a user interacting with a user interface of an ice dispensing system and selecting a desired beverage size or another system sending an input to the ice dispensing system via the system interface.

At step 504, the system interface communicates information indicating the received input to a processor of the ice dispensing system. At step 506, the processor receives the information indicating the input received at the system interface, and step 508, the processor determines control information for the gearmotor motor based on the received information.

At step 510, the processor transmits the control information the gearmotor. At step 512, a controller of the gearmotor receives the control information. At step 514, the controller provides power to the gearmotor, thereby causing the gearmotor to rotate. At step 516, the gearmotor rotates the ice wheel coupled to the gearmotor.

At step 518, ice positioned between adjacent paddles positioned around the ice wheel rotate with rotation of the ice wheel and ice fills into the pockets between adjacent paddles.

At step 520, as the ice wheel rotates, the baffle levels ice within the pockets and pushes excess ice into an area of the ice bin before a pocket rotates under the baffle to assist in filling the pockets between adjacent paddles of the ice wheel with ice.

At step 522, as the ice wheel rotates, and one or more pockets between adjacent paddles rotate over the aperture in the bottom of the ice bin, ice flows from the pocket, through the aperture, and into the dispense chute. The ice then flows out of the dispense chute and into a receptacle positioned below the dispense chute.

As the gearmotor rotates at step 516 and steps 518, 520, and 522 occur, at step 524, the capacitive senor monitors whether ice is present within a range of the capacitive sensor. While the capacitive senor determines that ice is present within the range of the capacitive sensor, the capacitive senor continues to monitor for ice as the ice dispense operation continues. However, when the capacitive sensor determines that ice is not present within the range of the capacitive sensor, at step 526, the capacitive sensor sends a low ice signal to the processor.

At step 528, the processor receives the low ice signal from the capacitive sensor, and at step 530, the processor determines whether a number of consecutive ice dispense operations during which the capacitive sensor generates a low ice signal is equal to a threshold. In some implementations, the processor may utilize a counter or another type of data structure to allow the processor to count a number of consecutive ice dispense operations during which the capacitive sensor generates a low ice signal. In some implementations, the processor may reset this counter or other data structure when the ice dispense system is refilled with ice.

When the number of consecutive ice dispense operations during which the capacitive sensor generates a low ice signal is not equal to a threshold, at step 532 the processor refrains from illuminating and/or activating an indicator. The above-identified steps are then continued for the next ice dispense operation.

However, when the number of consecutive ice dispense operations during which the capacitive sensor generates a low ice signal is equal to a threshold, at step 534, the processor illuminates and/or activates an indicator to alert a user to a low ice condition within the ice dispensing system.

As discussed above, in some implementations, the threshold for illuminating and/or activating the indicator may be set to a value of one such that the processor illuminates the indicator after the capacitive sensor generates a low ice signal for the first time. However, in other implementations, the threshold for illuminating the indicator may be set to a value with a higher number such that the processor illuminates the indicator after the capacitive sensor generates a low ice signal during three consecutive ice dispense operations, for example. By setting the threshold to a higher number such as three, it reduces a chance of false positives where the processor illuminating the low ice indictor even though sufficient ice is present with the ice dispense system.

Implementations of ice dispensing systems are described above in conjunction with FIGS. 1-5 that utilize a capacitive sensor to detect a low ice level with in an ice storage bin. Capacitive sensors can detect conductors and dielectrics through a plastic medium, thereby allowing a capacitive sensor to detect a presence of ice in an ice storage bin while being positioned adjacent to an exterior side of the ice storage bin. Because the capacitive sensor is positioned adjacent to the exterior side of ice storage bin, it is not in direct contact with ice in the ice storage bin and is not positioned in a food zone area of the ice storage bin.

Although certain embodiments and implementations of the disclosure have been specifically described herein, it will be apparent to those skilled in the art to which the disclosure pertains that variations and modifications of the various embodiments shown and described herein may be made without departing from the spirit and scope of the disclosure. Accordingly, it is intended that the disclosure be limited only to the extent required by the appended claims and the applicable rules of law.

1. A system comprising:
an ice bin;
a capacitive sensor positioned adjacent to the ice bin, the capacitive sensor configured to detect a presence of an ice nugget within a defined distance of the capacitive sensor;
a system interface comprising a low ice indicator;
a processor in communication with the capacitive sensor and the system interface, the processor configured to:
determine, during an ice dispensing operation of the ice dispensing system, whether the capacitive sensor generates a low ice level signal;
when the capacitive sensor generates the low ice level signal:
determine whether a number of consecutive ice dispensing operations during which the capacitive sensor generates the low ice level signal is equal to a threshold;
when the number of consecutive ice dispensing operations during which the capacitive sensor generates the low ice level signal is equal to a threshold, at least one of illuminate or activate the low ice indicator of the system interface; and
when the number of consecutive ice dispensing operations during which the capacitive sensor generates the low ice level signal is not equal to the threshold, refrain from illuminating or activating the low ice indicator of the system interface.

2. The system of claim 1, wherein the threshold is greater than one.

3. The system of claim 1, wherein the threshold is equal to one.

4. The system of claim 1, wherein:
an exterior of the ice bin is at least partially surrounded by insulation;
the capacitive sensor is positioned in a foam plug; and
the capacitive sensor and the foam plug are positioned adjacent to the ice bin within a void defined by the insulation.

5. The system of claim 4, wherein the system further comprises:
a bracket configured to hold the capacitive sensor and foam plug in position within the void of the insulation.

6. The system of claim 1, wherein the capacitive sensor is positioned on a side of the ice bin that ice is dispensed from the ice bin.

7. A method for operating an ice dispensing system utilizing a capacitive sensor, the method comprising:
determining, with a processor of the ice dispensing system, whether the capacitive sensor generates a low ice level signal during an ice dispensing operation of the ice dispensing system;
when the processor determines that the capacitive sensor generates the low ice level signal:
determining, with the processor, whether a number of consecutive ice dispensing operations during which the capacitive sensor generates the low ice level signal is equal to a threshold;
when the number of consecutive ice dispensing operations during which the capacitive sensor generates the low ice level signal is equal to a threshold, at least one of illuminating or activating, with the processor, an indicator of the ice dispensing system; and
when the number of consecutive ice dispensing operations during which the capacitive sensor generates the low ice level signal is not equal to the threshold, refraining from illuminating or activating the indicator of the ice dispensing system.

8. The method of claim 7, wherein the threshold is greater than one.

9. The method of claim 7, wherein the threshold is one.

10. The method of claim 7, wherein the capacitive sensor is positioned in the ice dispensing system adjacent to an ice bin of the ice dispensing system.

11. The method of claim 10, wherein:
an exterior of the ice bin is at least partially surrounded by insulation;
the capacitive sensor is positioned in a foam plug; and
the capacitive sensor and the foam plug are positioned adjacent to the ice bin within a void defined by the insulation.

12. The method of claim 7, wherein the indicator is part of a user interface of the ice dispensing system.
